(19) United States
(12) Patent Application Publication
(10) Pub. No.: US 2011/0301021 A1
(43) Pub. Date: Dec. 8, 2011

(54) PROMOTED ZIRCONIUM OXIDE CATALYST SUPPORT

(75) Inventors: Aiguo Liu, Louisville, KY (US); Todd J. Cole, II, Louisville, KY (US); Wayne Turbeville, Crestwood, KY (US)

(73) Assignee: SUD-CHEMIE INC., Louisville, KY (US)

(21) Appl. No.: 13/201,892

(22) PCT Filed: Mar. 3, 2010
(86) PCT No.: PCT/US10/00650

§ 371 Date: Aug. 17, 2011

Related U.S. Application Data
(60) Provisional application No. 61/156,859, filed on Mar. 2, 2009.

(51) Int. Cl. B01J 21/06; B01J 27/135; B01J 27/25; B01J 31/34; B01J 31/38; B01J 27/02; B01J 23/28; B01J 23/30; B01J 32/00; B01J 35/10; B01J 27/18; B01J 35/02; B01J 23/26

(52) U.S. Cl. 502/170; 502/100; 502/308; 502/227; 502/201; 502/171; 502/349; 502/439; 502/300; 502/208; 502/216

(57) ABSTRACT

A polyacid-promoted, zirconia catalyst or catalyst support having a high crush strength, surface area and pore volume is described. The polyacid-promoted, zirconia catalyst or catalyst support may be made by combining a zirconium compound with a polyacid/promoter material that includes the group 6 metals (i.e., chromium (Cr), molybdenum (Mo), tungsten (W)), as well as phosphoric acids, sulfuric acids, and polyorganic acids. The zirconyl-promoter precursor may be extruded in the absence of any binder or extrusion aid. The polyacid-promoted, zirconia catalyst or catalyst support is hydrothermally stable in aqueous phase hydrogenation or hydrogenoloysis reactions.

### CROSS REFERENCE TO RELATED APPLICATION

This application claims the benefit of U.S. Provisional Application No. 61/156,859, filed on Mar. 2, 2009, the contents of which are incorporated by reference herein. This application is related to International Patent Application PCT/US2010/XXXXX, filed Mar. 2, 2010.

### TECHNICAL FIELD

This application includes embodiments and claims pertaining to a catalyst and/or catalyst support/carrier. One or more embodiments of the invention pertain to a zirconium oxide catalyst or catalyst support/carrier in which the zirconium oxide is promoted by the use of a polyacid or another promoter material. Other embodiments are directed to methods of making the catalyst or catalyst support and uses of a catalyst in converting sugars, sugar alcohols, or glycerol to commercially-valuable chemicals and intermediates.

### BACKGROUND ART

Zirconium oxide, also referred to as zirconia, is a known high temperature refractory material with extensive industrial applications. It is also a known catalyst support material because of its high physical and chemical stability and moderate acidic surface properties. Nonetheless, the use of zirconia as a supporting material for heterogeneous catalysts has limited application due to its relatively high cost and difficulties in forming certain shapes from this material. Furthermore, the zirconia often undergoes a phase transformation that results in loss of surface area and pore volume. This reduces the strength and durability of the zirconia. To counteract the phase transformation effects, stabilizing agents are used to inhibit phase transformation from the preferable tetragonal phase to the less desirable monoclinic phase.

One non-exhaustive example of technology directed to making zirconia catalyst supports is described in WO 2007/092367 (filed by Saint-Gobain), which discloses a formed ceramic body comprising tetragonal zirconia as the primary phase with a surface area greater than 75 m²/g and a pore volume of over 0.30 mL/g. In one aspect of the invention, a process for making a zirconia carrier is described and is further defined by the use of inorganic or organic binder(s) and/or stabilizing agents. The stabilizing agents may be selected from among silicon oxide, yttrium oxide, lanthanum oxide, tungsten oxide, magnesium oxide, calcium oxide and cerium oxide.

Another non-exhaustive example is described in U.S. Pat. No. 5,391,362 (issued to Reinalda et al. and assigned to Shell Oil Company), which discloses and claims a process for manufacturing high surface area zirconia. The disclosure indicates preferences for surface areas above 125 m²/g, 150 m²/g, and 200 m²/g respectively, and claiming a process that yields zirconia possessing a surface area above 200 m²/g in particular. As claimed, the process includes the precipitation of zirconium hydroxide from a solution of zirconium compound in water through mixing of the solution with an alkali compound (e.g. ammonia, urea, hexamethylene tetramine, ethanolamines, sodium hydroxide, and potassium hydroxide). Then, the zirconium hydroxide precipitate is washed with water to remove the alkali compound, which is then aged in the presence of a various forms of phosphoric acid and calcined at a temperature between 250° C. and 550° C. Although Reinalda teaches that the zirconium hydroxide precipitate can be aged in the presence of an oxygen acid of an element of group 5 or 6, only the use of phosphoric acids are fully described. Moreover, Reinalda does not teach co-precipitating the zirconium hydroxide with the group 5 or 6 oxygen acid.

Yet another non-exhaustive example is described in U.S. Patent Application 2007/0036710 (filed on behalf of Fenouil et al. and Shell Oil Company), which discloses a process for preparing calcined zirconia extrudate. In particular, the application recites a process for producing higher olefins in which hydrogen and carbon monoxide are contacted under Fischer Tropsch reaction conditions in the presence of a zirconia extrudate having cobalt as the catalytically active metal. The zirconia extrudate is prepared by mixing a particulate zirconia that possesses no more than about 15% by weight of zirconia which is other than monoclinic phase zirconia. Or in other words, Fenouil teaches the a zirconia that consists essentially of the monoclinic phase, which corresponds to approximately 85 wt. %, is preferred over tetragonal zirconia or a mixture of monoclinic or tetragonal zirconia containing more than 15 wt. % of a phase which is not the monoclinic phase. In Fenouil, the cobalt catalyst may be deposited by impregnation on the zirconia extrudate or co-milled with the particulate zirconia and a solvent and then extruded. The zirconia extrudate exhibits certain measurable characteristics, including having a pore volume of approximately 0.3 mL/g or more, a crush strength of approximately 100 N/cm (˜2.5 lb/mm), and a surface area of 50 m²/g or more, respectively.

Physical and chemical stability is a major concern in the application of heterogeneous catalysts in aqueous phase reactions. Traditional SiO₂ or Al₂O₃ based catalyst supports are prone to disintegration or attack when used in an aqueous solution, which usually results in loss of mechanical strength of the catalyst body that is targeted for a long-term industrial application. In laboratory and industrial applications, the mechanical strength of heterogeneous catalysts is generally evaluated by crush strength, wherein increasing crush strength values are generally indicative of improved mechanical strength of the support or carrier.

It has now been found that zirconia promoted with a polyacid or a similarly-functioning promoter material yields a zirconia-based support or catalyst with improved physical properties for extrusion and/or use as a carrier or support for a catalyst in industrial applications performed in an aqueous environment. It is now found that use of a polyacid-promoted zirconia support or catalyst inhibits metal leaching into an aqueous solution, improving the mechanical strength and stability of the support/carrier or catalyst.

Certain embodiments of the invention represent improvements in supports or carriers utilized in catalysts, and/or improvement(s) in catalyst(s). Certain other embodiments of the invention represent improvements in catalytic reactions in which the improved support/carrier and/or catalyst is utilized.

### DISCLOSURE OF EMBODIMENTS OF THE INVENTION

A hydrothermally-stable, extruded catalyst or catalyst support comprising a zirconium compound and a polyacid/promoter material is described wherein the zirconium compound and polyacid/promoter material are combined to form a zirconium-promoter precursor having a molar ratio between 2:1 and 20:1. The polyacid/promoter material may be a polyacid such as phosphoric acid, sulfuric acid, or polyorganic acids. Alternatively, the polyacid/promoter material may be the oxide or acid form of the Group 6 (Group VIA) metals, including chromium, molybdenum, or tungsten. The zirconium-promoter precursor may be extruded in the absence of any binder, extrusion aid or stabilizing agent.

In another embodiment, a hydrothermally-stable, extruded catalyst or catalyst support consists essentially of a zirconium compound and a polyacid/promoter material. The polyacid/promoter material may comprise the oxide or acid form of chromium and the zirconium to polyacid/promoter material may have a molar ratio between 4:1 and 16:1. Similarly, the zirconium-promoter precursor may be extruded in the absence of any binder, extrusion aid or stabilizing agent.

In a further embodiment, a method of preparing a catalyst or catalyst support is described that comprises, or consists essentially of, a zirconium compound and a polyacid/promoter material. The method includes providing a zirconium compound and a polyacid/promoter material selected from the group consisting of a polyacid, a polyacid comprising the oxide or acid form of chromium (Cr), molybdenum (Mo), or tungsten (W), phosphoric acid, sulfuric acid, acetic acid, citric acid, and combinations thereof. The zirconium compound may be mixed with the polyacid/promoter material in an amount that yields a solution having an molar ratio of zirconium to polyacid/promoter material between 2:1 and 20:1. A zirconium-promoter precursor may be precipitated by mixing an aqueous basic solution with the zirconium-promoter solution. Alternatively, the zirconium compound may be precipitated, washed and mixed with the polyacid/promoter material to form the zirconium-promoter precursor. The zirconium-promoter precursor may be dried and formed into a shape suitable as a catalyst or catalyst support. Preferably, the catalyst or catalyst support is formed by extrusion that can be done in the absence of any binder, extrusion aid or stabilizing agent. Finally, the extruded zirconium-promoter precursor may be calcined to form the finished, hydrothermally-stable, catalyst or catalyst support, which may be used in a variety of industrial processes, including aqueous phase hydrogenation or hydrogenoloysis reactions.

### MODES FOR CARRYING OUT EMBODIMENTS OF THE INVENTION

Certain embodiments of the invention include the product and process of making a catalyst or catalyst support/carrier comprising zirconium oxide (ZrO₂) promoted by a polyacid or a functionally-similar, promoter material, generally referred to as the “polyacid/promoter material.” The polyacid/promoter material may comprise materials from the Group 6 (Group VIA) metals including chromium (Cr), molybdenum (Mo), and tungsten (W), as well as phosphorous acids, sulfuric acid, acetic acid, citric acid and other polyorganic acids. As used herein, unless otherwise qualified, the term polyacid(s) refers to a chemical or composition having more than one multi-donor proton in acid form. The finished catalyst or catalyst support/carrier may have a molar ratio of zirconium to promoter (Zr:Promoter) between 2:1 and 20:1.

In another embodiment, a method of preparing a catalyst or catalyst support comprising, or alternatively, consisting essentially of, a zirconium compound and a promoter includes mixing a polyacid/promoter material selected from the group consisting of a polyacid, a polyacid comprising the oxide or acid form of chromium (Cr), molybdenum (Mo), tungsten (W), and combinations thereof with a zirconium compound. The zirconium compound and the polyacid/promoter material may be co-precipitated by mixing an aqueous basic solution to form a zirconium-promoter precursor. Alternatively, the zirconium compound may be precipitated first and then the polyacid/promoter material may be mixed with the precipitated zirconium to form the zirconium-promoter precursor. The zirconium-promoter precursor can then be dried, shaped and calcined in accordance with well-known processes to form a finished catalyst or catalyst support. The finished catalyst or catalyst support may have a molar ratio of Zr:Promoter between 2:1 and 20:1.

Other embodiments of the invention are directed to the use of the catalyst support and at least one catalytically active metal to form a catalyst for the conversion of sugars, sugar alcohols or glycerol into commercially-valuable chemical products and intermediates, including, but not limited to, polyols or an alcohol comprising a shorter carbon-chain backbone such as propylene glycol (1,2-propanediol), ethylene glycol (1,2-ethanediol), glycerin, trimethylene glycol (1,3-propanediol), methanol, ethanol, propanol and butandiols. As used herein, unless otherwise qualified, the term polyol(s) refers to any polyhydric alcohol containing more than one hydroxyl group. As broadly defined, polyol may encompass both the reactants and/or the products described above.

The zirconium may be selected from the group consisting of zirconium or zirconyl halides, zirconium or zirconyl nitrates, or zirconyl organic acids, and combinations thereof. The zirconium compounds may comprise a variety of materials, including zirconium and zirconyl in salt forms of halides such as ZrCl₄ or ZrOCl₂; nitrates such as Zr(NO₃)₂.5H₂O or ZrO(NO₃)₂, and organic acids such as ZrO(CH₃COO)₂. Other zirconium compounds are envisioned and not limited to those specifically identified herein. In solution, zirconium can be in a form of zirconyl (ZrO²⁺) or zirconium ion (Zr⁴⁺ or Zr²⁺) that may be obtained by dissolving corresponding salts in water.

The polyacid/promoter material may be the Group 6 metals comprising chromium (Cr), tungsten (W), and molybdenum (Mo) in oxide or acid form(s) that form a polyacid after being dissolved in a water solution. In one embodiment, the polyacid may be selected from the group consisting of CrO₃, Cr₂O₃, and combinations thereof. In another preferred embodiment, the polyacid/promoter material is Cr⁶⁺ or Cr(VI), as may be found in CrO₃. In yet other embodiments, the polyacid/promoter material may be selected from the group consisting of phosphoric acid, sulfuric acid, acetic acid, citric acid and combinations thereof.

One embodiment for preparing a catalyst or catalyst support/carrier characterized by having a zirconium oxide (ZrO₂) base involves preparing a zirconium compound and a polyacid/promoter material and then mixing these compounds in acidic conditions having a pH ranging from about 0.01 to about 4. A base solution may be introduced for promoting precipitation of the desired precipitate. The base solution may include aqueous ammonia, aqueous sodium hydroxide, or other aqueous basic solutions for adjusting the pH conditions to yield a zirconium salt precipitate. In another embodiment, the polyacid/promoter material is initially dissolved in a base solution, such as ammonia hydroxide, followed by mixing with the zirconium compound.

In various embodiments, the initial molar ratio of the zirconium to the polyacid/promoter material (Zr:Promoter) may fall in a range between 2:1 and 20:1; and alternatively between 4:1 and 16:1; or between 8:1 and 16:1; or about 12:1; or about 8:1. The final molar ratio of the zirconium and promoter may fall in a range of 2:1 to 20:1; and alternatively between 4:1 and 16:1; or between 8:1 and 16:1; or between about 10:1 and 14:1; or about 13:1; or about 12:1; or about 8:1. In one embodiment, a molar ratio of zirconium to chromium (Zr:Cr) may fall in a range between 4:1 and 16:1; and alternatively between 8:1 and 16:1, or between 10:1 and 14:1; or about 13:1; or about 12:1; or about 8:1.

In various embodiments, zirconyl nitrate (ZrO(NO₃)₂) and chromium oxide (CrO₃ (Cr VI) or Cr₂O₃ (Cr III) (polyacid/promoter material) serve as the respective starting materials for preparation of a catalyst or catalyst support/carrier. The initial molar ratio of the zirconium base metal and chromium polyacid/promoter material (Zr:Cr) may be in the range between 2:1 and 20:1, or alternatively between 4:1 and 12:1, or between 8:1 and 12:1 or between 6:1 and 10:1. The starting materials may be mixed under acidic conditions (e.g., a pH value approximately 0.01 to 1) to prevent hydrolyzing the catalyst and then pumped into a vessel or reactor and mixed with aqueous ammonia (15% NH₃) and stirred. The aqueous ammonia possesses a pH value of approximately 12.5. After mixing of the Zr/Cr solution with the aqueous ammonia, the pH value is within a range of 7.5 to 9.5. Optionally, if the pH value is beyond the range of 7.5 to 9.5, adjustments may be performed with the addition of the appropriate acidic or basic material(s) or solution(s) to bring the pH value within the range.

After mixing of the starting materials, the zirconium-promoter precipitate may be filtered and separated from the liquid, yielding a filtrate-cake. If filtered, a variety of methods and/or apparatuses may be utilized, including the use of filter paper and vacuum pump, as well as centrifugal separation, other vacuum mechanisms and/or positive pressure arrangements. In one embodiment, the drying of the filtrate-cake may be achieved by dividing (e.g., breaking) the filtrate-cake into smaller quantities to facilitate air drying at ambient conditions. The division (e.g. breaking) of the filtrate-cake may be manual or automated. Optionally, the filtrate-cake may be washed if any of the feed materials used in the process contain undesirable elements or compounds, such as chloride or sodium. Typically, one (1) to ten (10) washings, or even more washings may be required if undesired elements or other contaminants are present in the feed materials.

The precipitated zirconium-promoter precursor (in the form of a filtrate cake) may be dried at ambient conditions (e.g. room temperature and ambient pressure) or under moderate temperatures ranging up to about 120° C. In one embodiment, the zirconium-promoter precursor is dried at a temperature ranging between 40° C. and 90° C. for about 20 minutes to 20 hours, depending on the drying equipment used. In other embodiments, a heated mixer may be used to mix the zirconium precipitate with the polyacid/promoter material thereby allowing drying time to be reduced to less than 1 hour. In one embodiment, the zirconium-promoter precursor or only the precipitated zirconium is dried until a loss of ignition (“LOI”) is achieved in a range between about 60 wt. % to about 70 wt. %. As used herein, LOI may be understood as the weight loss percentage by ignition of the material at approximately 480° C. for approximately two (2) hours. In other embodiments, the zirconium-promoter precursor or the precipitated zirconium is dried until a LOI of about 64 wt. ° A) to 68 wt. % is achieved, and more preferably, about 65 wt. % to 68 wt. %.

In the various embodiments, the zirconium-promoter precursor may be dried to achieve a mixture that is suitable for extrusion without any binder(s), extrusion aid(s), or stabilizing agent(s). In other words, the zirconium-promoter precursor is dried to be capable of forming a shape suitable for a finished catalyst or catalyst support/carrier in the absence of any stabilizing agent, binder or extrusion aid. The following compounds have been described in the prior art as a stabilizing agent, binder, or extrusion aid, and all of these compounds are absent in one or more embodiments described in this application: silicon oxide, yttrium oxide, lanthanum oxide, tungsten oxide, magnesium oxide, calcium oxide, cerium oxide, other silicon compounds, silica-alumina compounds, graphite, mineral oil, talc, stearic acid, stearates, starch, or other well-known stabilizing agent, binder or extrusion aid.

Forming of the dried zirconium-promoter precursor into any shape suitable for a finished catalyst or catalyst support/carrier maybe done by any of forming processes that are well known in the art. In a preferred embodiment, the dried zirconium-promoter precursor is extruded. A screw extruder, press extruder, or other extrudation devices and/or methods known in the art may be used. Alternatively, the dried zirconium-promoter precursor may be pressed such as by tabletting, pelleting, granulating, or even spray dried provided the wetness of the dried zirconium-promoter precursor is adjusted for the spray-drying material, as is well-known in the art. Optionally, the extruded zirconium-promoter precursor may be dried at moderate temperatures (e.g., up to about 120° C.) for a moderate period of time (e.g., typically about 1 to 5 hours) after being formed.

The extruded or other shaped catalyst or catalyst support/carrier may be calcined at temperatures ranging from about 300° C. to 1000° C. for approximately 2 to 12 hours, and preferably from about 400° C. to 700° C. for approximately 3 to 5 hours. In one embodiment, an extruded chromium-promoted zirconium oxide precursor is calcined at about 600° C. for approximately three hours. Alternatively, an extruded chromium promoted zirconium oxide precursor may be calcined at a ramp of 1 degree per minute (abbreviated as “deg/m” or “° C./m” or “°/min”) to 600° C. and dwell for approximately 3 hours. In another embodiment, an extruded polyacid-promoted zirconium precursor is calcined at about 300° C. to 1000° C., or at about 400° C. to 700° C., or at about 500° C. to 600° C. for approximately 2 to 12 hours.

Using the various method embodiments described above, the finished product is a polyacid-promoted zirconium oxide catalyst or catalyst support/carrier having a crystalline structure of one or more of the monoclinic, tetragonal, cubic and/or amorphous phases as determined by well-known powder x-ray diffraction (XRD) techniques and devices. For example, see “Introduction to X-ray Powder Diffraction,” R. Jenkins and R. L Snyder, Chemical Analysis, Vol. 138, John Wiley & Sons, New York, 1996. Typically, the tetragonal phase of zirconium oxide may be determined by measuring the intensity of a sample at a d-spacing of 2.97 angstroms (Å), while the monoclinic phase is measure at a d-spacing of 3.13 angstroms (Å). In other embodiments, the finished catalyst or catalyst support/carrier may be further characterized as comprising about 50 wt. % to 100 wt. % tetragonal phase of zirconium oxide as its crystalline structure. In another embodiment, the finished catalyst or catalyst support may be further characterized as comprising 0 to 50 wt. % monoclinic phase of zirconium oxide. Alternatively, the crystalline structure may comprise above 80 wt. % tetragonal phase of zirconium oxide, or about 85 wt. % tetragonal phase of zirconium oxide.

For a catalyst or catalyst support/carrier comprising a Zr/Cr composition, the more chromium used in the process, the more tetragonal phase crystalline structure is achieved as product. For example, a 4:1 molar ratio yields almost 100% tetragonal phase of zirconium oxide. An 8:1 molar ratio yields almost 100% tetragonal phase of zirconium oxide. At a 12:1 molar ratio, the crystalline structure is approximately 85 wt. % to 90 wt. % tetragonal phase and approximately 15 wt. % to 10 wt. % monoclinic phase of zirconium oxide.

The polyacid-promoted zirconium oxide catalyst or catalyst support/carrier as described above may have a crush strength in a range between 67 N/cm (1.5 lb/mm) and 178 N/cm (4.0 lb/mm.) Alternatively, the catalyst or catalyst support has a minimum crush strength of at least 45 N/cm (1 lb/mm) or at least 90 N/cm (2 lb/mm), depending on its use. The crush strength of a catalyst or catalyst support/carrier may be measured using ASTM D6175-03 (2008), Standard Test Method for Radial Crush Strength of Extruded Catalyst and Catalyst Carrier Particles.

In other embodiments, the finished polyacid-promoted zirconium oxide catalyst or catalyst support/carrier may have a surface area as measured by the BET method in a range between 20 m²/g and 150 m²/g. Alternatively, the finished zirconium oxide catalyst or catalyst support/carrier may have a surface area in a range between 80 m²/g and 150 m²/g, and preferably about 120 m²/g and 150 m²/g.

The polyacid-promoted zirconium oxide catalyst or catalyst support/carrier may also have a pore volume in a range between 0.10 cc/g and 0.40 cc/g. Generally, for initial molar ratios between 4:1 and 16:1, the pore volume consistently yields values in a range between 0.15 cc/g and 0.35 cc/g. For initial molar ratios approximately 8:1, the pore volume consistently yields values in a range between 0.18 cc/g and 0.35 cc/g.

### INDUSTRIAL APPLICABILITY

The polyacid-promoted zirconium oxide support/carrier may be combined with one or more catalytically active metals to form a catalyst for use in many industrial processes, including aqueous phase reactions under elevated temperature and pressure conditions. In one embodiment, an extruded chromium-promoted zirconium oxide support exhibits high hydrothermal stability and provides a durable support/carrier for aqueous phase hydrogenation or hydrogenoloysis reactions, such as the conversion of glycerol or sorbitol. In other embodiments, a polyacid-promoted zirconia support maybe used as a catalyst or catalyst support/carrier in other industrial processes, including aqueous, hydrocarbon and mixed phases.

### EXAMPLES

The following examples are for illustrative purposes disclosing multiple embodiments of the invention, and are not a limitation on the embodiments and/or the claims presented herein. Unless otherwise designated, chemicals or materials designated by a percentage refer to weight percentage (wt. %) of the chemical or material. As used herein “selectivity” or “molar selectivity” is defined as the percentage of carbon in a particular product over the total consumed carbon in the feed.

### Example 1

### Chromium (VI) Promoter

A first solution (Solution 1) was prepared using 10 g of CrO₃ dissolved in 10 mL of de-ionized water (hereinafter referred to as “DI-H2O”). Solution 1 was then mixed with 500 g of zirconium nitrate solution (20% ZrO₂). A second solution (Solution 2) was prepared using 400 mL DI-H₂O and 250 mL of ammonia hydroxide solution (30%). Solution 1 was transferred into Solution 2 drop-wise with concurrent stirring. The pH of the mixed solutions (Sol. 1 and Sol. 2) dropped from approximately 12 to approximately 8.5.

Precipitation occurred due to a decrease in the pH value. The precipitate was left in the mother liquor to age for approximately one hour. Similar to Examples 2 and 3 described below, the precipitate is processed in a relatively consistent manner. The generated precipitate was filtered without washing. The filter cake was manually divided into smaller portions and left to dry under ambient temperature for approximately four days to reach an LOI in a range between about 65 wt. % and 68 wt. %. The dried filter cake was then ground and extruded with a ⅛″ die yielding a ⅛″ extrudate material. The extrudate was additionally dried at approximately 120° C. for approximately 3 hours. Thereafter, the extrudate was calcined at a ramp of 1 deg/m to 600° C. for approximately 3 hours.

The obtained extrudate had a surface area of approximately 63 m²/g, a pore volume of approximately 0.22 cc/g and a crush strength value of approximately 134 N/cm (3.02 lb/mm.) The calcined extrudate material was generally comprised of a mixture of tetragonal phase and monoclinic phase ZrO₂ as interpreted and indicated by the XRD data.

### Example 2

### Chromium (VI) Promoter—NH₄OH (Aqueous Basic Solution)

300 mL of concentrated NH₄OH (28-30%) was diluted with 500 mL DI-H2O and loaded into a 2000 mL tank reactor. The reactor was then preheated to 35° C. A solution of 500 g zirconium nitrate solution (20% wt ZrO₂) was preheated to 35° C. and pumped into the reactor tank in a one hour period under vigorous stirring. The pH of the solution decreased from a value of about 12.5 to approximately 8.5. After aging for an hour under slower stirring; the precipitate was filtered. The obtained filter cake was then mixed with 10 g CrO₃ by mechanical stirring for about an hour. The obtained mixture was dried under vacuum at 35° C. to 40° C. until LOI reached a range and about 65 wt. % to about 70 wt. %. The dried powder was then extruded and calcined under a temperature program of ramp at 5° C./min to 110° C., hold (dwell) for 12 hours, ramp at 5° C./min to 600° C. and hold for 6 hours. Typical properties of the obtained extrudates include a crush strength of 137 N/cm (3.08 lb/mm), a pore volume of 0.21 cc/g, and a surface area of 46 m²/g. XRD analysis showed a mixture of tetragonal phase (d=2.97 Å) and monoclinic phase of ZrO₂ (d=3.13 Å).

### Example 3

### Chromium (VI) Promoter—NaOH (Aqueous Basic Solution)

NaOH instead of NH₄OH was used for this preparation. A total of 500 mL of 25% wt NaOH solution was preheated to 35° C. 200 mL of the NaOH solution and 1200 mL DI-H₂O was loaded into a 2000 mL tank reactor. A solution of 500 g zirconyl nitrate solution (20% wt ZrO₂) was preheated to 35° C. and pumped into the tank reactor in a one hour period under vigorous stirring. The 25% NaOH solution was added as necessary when pH dropped below 8.5 during the precipitation. After aging for an hour under slower stirring, the precipitate was filtered. The filter cake was re-slurred with DI-H₂O in 1:1 volumetric ratio and stirred for 15 min before filtration. The same procedure was repeated until conductivity of the filtrate was below 200 μS, which usually required washing the filter cake about 4 to 8 times. The washed filter cake was then mixed with 10 g CrO₃ and dried at 70° C. until 64 wt. % to 70 wt. % LOI was achieved. A similar procedure as described in Example 2 was followed for extrusion and calcinations of the filter cake. Typical properties of the obtained extrudates include a crush strength of 94 N/cm (2.12 lb/mm), a pore volume of 0.23 cc/g, and a surface area of 94 m²/g. XRD analysis showed a mixture of tetragonal phase (d=2.97 Å) and monoclinic phase of ZrO₂ (d=3.13 Å).

### Example 4

### Chromium (III) Nitrate Promoter

55 g of chromium (III) nitrate solution (9.6% wt Cr) was mixed with 500 g zirconyl nitrate solution (20% wt ZrO₂). Similar precipitation and washing procedure as example 2 were applied. After washing, similar drying, extrusion and calcination procedures as described in Example 3 were applied. Typical properties of the obtained extrudates include a crush strength of 111 N/cm (2.49 lb/mm), a pore volume of 0.33 cc/g, and a surface area of 136 m²/g. XRD analysis showed a mixture of tetragonal phase (d=2.97 Å) and monoclinic phase of ZrO₂ (d=3.13 Å).

### Example 5

### Phosphorous Promoter

125 g of zirconyl nitrate solution (having about 20% Zr as ZrO₂) was diluted by the addition of DI-H₂O to a total mass of 400 g. Thereafter, 12 g of 85% H₃PO₄ was added drop-wise to the diluted zirconyl nitrate solution with concurrent stirring to yield an initial molar ratio of Zr/P equal to 2:1. A gel formation was observed. The mixed solution was continuously stirred for another 30 minutes at ambient temperature. NH₃H₂O was added drop-wise afterward until a total gel formation with a pH having a value in the range of 6.5 to 7.5 was produced.

An additional quantity of DI-H₂O was added, approximately 100 mL, with continuous stirring for approximately 12 hours under ambient temperature to disperse the gel formation. The generated precipitate was filtered without washing. The filter cake was manually divided into smaller portions and left to dry in the air under ambient temperature for approximately four days. The dried filter cake was then ground and extruded. The extrudate was additionally dried at approximately 120° C. for approximately 3 hours. Thereafter, the extrudate was calcined at a ramp of 1 deg/m to 600° C. for approximately 3 hours.

The obtained extrudate material had a surface area of approximately 19 m²/g, a pore volume of approximately 0.19 cc/g and a crush strength value of approximately 85 N/cm (1.9 lb/mm.) The calcined extrudate material was generally comprised of amorphous phase ZrO₂ as interpreted and indicated by the XRD data.

### Example 6

### Phosphorous Promoter

The procedure as provided in Example 5 above was utilized, except that 250 g of zirconyl nitrate solution was used in order to obtain an initial molar ratio of Zr/P of approximately 4:1. The obtained extrudate had a surface area of approximately 20.9 m²/g, a pore volume of approximately 0.19 cc/g and a crush strength value of approximately 76 N/cm (1.7 lb/mm.) The calcined extrudate material was generally comprised of amorphous phase ZrO₂ as indicated by the XRD data.

### Example 7

### Tungsten Promoter

A first solution (Solution 1) was prepared by dissolving 25 g of H₂WO₄ (tungstic acid) in a mixed solution of 200 mL of 30% ammonia hydroxide and 200 mL of DI-H₂O. 250 g of zirconyl nitrate solution (20% ZrO₂) was prepared (Solution 2). Both Solution 1 and Solution 2 were preheated to approximately 30° C. Then, Solution 2 was added to Solution 1 drop-wise which facilitated precipitation of a zirconyl salt. The precipitate was aged in the mother liquor for approximately one hour at approximately 30° C. Thereafter, the precipitate was processed in a manner consistent with the processing procedure stated in Example 5 above.

The obtained extrudates had a surface area of approximately 40.6 m²/g, a pore volume of approximately 0.168 cc/g and a crush strength value of approximately 125 N/cm (2.81 lb/mm.) The calcined extrudates were generally comprised of amorphous phase ZrO₂ as indicated by the XRD data.

### Example 8

### Molybdenum Promoter

An extrudate material of zirconium/molybdenum (Zr/Mo) may be prepared in a manner essentially consistent with the preparation and procedures provided in Example 4. The starting material providing the Mo source may be (NH₄)₂MoO₂ xH₂O.

### Example 9

### Effect of Polyacid/Promoter Material Choice

In addition to the aforementioned examples, additional experiments were conducted consistent with the examples provided above, wherein one or more supports were prepared in which the initial molar ratio (target) was approximately 4:1 in relation to the zirconium base compared to the polyacid/promoter material. Table 1 provides data from such experiments and examples, wherein the prepared extrudate includes a zirconium/phosphorous support, a zirconium/tungsten support, and a zirconium/chromium support, respectively. The zirconium/chromium support and zirconium/tungsten support data indicates a useful support may be obtained as seen by relatively high crush strength and surface area values.

TABLE 1

| SUPPORT | Zr/P | Zr/W | Zr/Cr |
|---|---|---|---|
| Molar Ratio | 4:1 | 4:1 | 4:1 |
| (Zr:promoter) | | | |
| Crush Strength | 1.71 lb/mm | 3.85 lb/mm | 3.79 lb/mm |
| Surface Area | 20.9 m²/g | 28.9 m²/g | 36.9 m²/g |
| Pore Volume | 0.191 cc/g | 0.155 cc/g | 0.197 cc/g |
| Crystalline | Amorphous | Amorphous | Tetragonal |
| Structure | | | |

### Example 10

### Chromium (VI) Promoter—8:1 Initial Molar Ratio

The following preparation and procedure serves as one representative and non-exhaustive model of a Zr/Cr extrudate material, wherein the initial molar ratio is approximately 8:1. 6.4 L of DI-H₂O and 4 L of ammonium hydroxide (28-30% NH₃) were combined in a 20 L precipitation tank equipped with a heating jacket and continuous mixing. The resulting solution was heated to 35° C. 160 g of chromium (VI) oxide (CrO₃) was dissolved in 80 mL of DI-H₂O. The chromium solution was then mixed with 8000 g of zirconyl nitrate solution (20% ZrO₂). The chromium/zirconyl solution was then heated to 35° C. and pumped into the tank at a rate between 50 mL and 60 mL per minute. During the precipitation of the zirconyl salt, the pH was controlled at a minimum pH value of 8.5 by adding ammonium hydroxide as needed. After finishing the pumping, the precipitate was aged in mother liquor for approximately one hour.

The precipitate was then filtered, and then divided into small portions, and left to dry at ambient conditions. The material was allowed to dry until the LOI was in a range of 60% to 68%. The precipitate was then mixed and extruded (through a ⅛″ die that generated a ⅛″ extrudate) by using a lab screw extruder. The extrudate was then dried overnight (12 hours) at 110° C. and then was calcined in a muffle furnace with a temperature program of ambient temperature ramp at 5° C. per minute to 110° C. and dwell for approximately 2 hours, then to 600° C. at 5° C. per minute and dwell for 3 hours.

### Example 11

### Variations of Molar Ratio

Variations of the initial molar ratio (target) may be achieved in a manner consistent with the preparation and procedures provided in Example 8 above. Table 2 represents the data generated from Example 9, as well as other examples at the different initial molar ratios of 4:1, 12:1 and 16:1, respectively.

TABLE 2

| SUPPORT | Zr/Cr | Zr/Cr | Zr/Cr | Zr/Cr |
|---|---|---|---|---|
| Molar Ratio | 4:1 | 8:1 | 12:1 | 16:1 |
| (Zr:Promoter) | | | | |
| Crush | 3.79 lb/mm | 1.5 lb/mm | 2.1 lb/mm | 0.79 lb/mm |
| Strength | | | | |
| Surface Area | 36.9 m²/g | 30-38 m²/g | 35.3 m²/g | 33.9 m²/g |
| Pore Volume | 0.197 cc/g | 0.202 cc/g | 0.192 cc/g | 0.227 cc/g |

### Example 12

### Comparative Example—No Polyacid/Promoter Material

A 100 g solution of zirconyl nitrate (20% ZrO₂) was prepared and added drop-wise into a 200 mL solution of diluted NH₃H₂O (15%). The mixing of the solutions yielded a change in pH from a value of approximately 12 to approximately 10. The pH value change facilitated zirconium precipitation. The precipitate was aged in the mother liquor for approximately 12 hours at ambient temperature. The final pH value was approximately 8.4. Thereafter, the precipitate was processed in a manner consistent with the processing procedure stated in Example 5 above. The obtained extrudate material possessed a crush strength value of approximately 22 N/cm (0.5 lb/mm.)

Based on the Examples provided above, it is envisioned that such a support/carrier may be used with one or more catalytically active metals for use in the conversion of glycerol or sugar alcohols into polyols or alcohols having fewer carbon and/or oxygen atoms, including, but not limited to, propylene glycol (1,2-propanediol), ethylene glycol (1,2-ethanediol), glycerin, trimethylene glycol (1,3-propanediol), methanol, ethanol, propanol, butandiols, and combinations thereof. Typical catalytically active elements for use in the conversion of glycerol and sugar alcohols include, but are not limited to, Group 4 (Group IVA), Group 10 (Group VIII) and Group 11 (Group IB) metals, such as copper, nickel, tin, ruthenium, rhenium, platinum, palladium, cobalt, iron and combinations thereof.

### Example 13

### Glycerin to Propylene Glycol—Cr Promoted Support/Cu Catalyst)

A Zr/Cr support or carrier prepared in a manner consistent with the processes described above has been found particularly useful in the selective conversion of glycerin to propylene glycol. In one embodiment, the Zr/Cr support/carrier is dipped in or impregnated to achieve a copper (Cu) load in the range of approximately 5%-30%. The Cu—Zr/Cr catalyst cracks the carbon-oxygen bond in glycerin and enables conversion of glycerin to propylene glycol. As summarized in Table 3 below, one sample provides approximately 15% copper load and achieved a conversion of 72% and a selectivity for propylene glycol (PG) of 85 molar %. Another sample provides a 10% copper load, and yields a conversion of approximately 42% of the glycerin, and selectivity for propylene glycol of approximately 82 molar %.

TABLE 3

| | | |
|---|---|---|
| Cu Load (%) | 15 | 10 |
| Conversion of Glycerin | 72 | 42 |
| (%) | | |
| Selectivity for PG | 85 | 82 |
| (molar %) | | |

### Example 14

### Sorbitol to Propylene Glycol—Cr Promoted Support/Ni—Sn Catalyst)

A Zr/Cr support or carrier prepared in a manner consistent with the processes described above has been found particularly useful in the selective conversion of sorbitol to propylene glycol, ethylene glycol and glycerin. In one embodiment, the Zr/Cr support or carrier is co-dipped in or co-impregnated to achieve a nickel (Ni) load in the range of 10% to 30% and a tin (Sn) promoter in the range of 300-5000 parts per million (ppm). The nickel catalyst/tin promoter, on the Zr/Cr support, crack both the carbon-carbon and the carbon-oxygen bonds in sorbitol and enables conversion of sorbitol to a mix of propylene glycol, ethylene glycol and glycerin, as well as other minor compounds such as methanol, ethanol, propanol and butandiols. As summarized in Table 4 below, one sample provides a target load value of 10% nickel and 300 ppm tin. The tests were run in a fixed bed reactor. After loading, the catalysts were reduced under 100% H₂, 500° C. and ambient pressure at GSHV of 1000/hr for 8 hours. After reduction, a 25 wt. % sorbitol feed consisting of a molar ratio of Sorbitol/NaOH of 10:1 was pumped through the reactor under 120 bar and 210° C. under LSHV=1/hr, H₂/sorbitol molar ratio of 10:1. This load combination generates a conversion of 70.6% having selectivity for propylene glycol of 36.6 molar %, 14.7 molar % for ethylene glycol and 20.9 molar % for glycerin. In another sample, a target load value of 10% nickel and 700 ppm tin generates a conversion of 75.8° A) and selectivity for propylene glycol of 27.5 molar %, 12.4 molar % for ethylene glycol and 20.7 molar % for glycerin.

TABLE 4

| Ni Load (%) | | 10 | 10 |
|---|---|---|---|
| Sn Load (ppm) | | 300 | 700 |
| Conversion of Sorbitol (%) | | 70.6 | 75.8 |
| Selectivity | PG | 36.6 | 27.5 |
| (molar %) | EG | 14.7 | 12.4 |
| | Glycerin | 20.9 | 20.7 |

### Example 15

### Sorbitol to Propylene Glycol—Cr Promoted Support/Ni—Cu Catalyst

The extrudates prepared by co-precipitation of Zr and Cr(VI) (refer to Example 10 above) were loaded with 10% Ni and 1% Cu by incipient wetness. After calcinations, the catalyst was loaded to a tubular reactor and reduced under 100% H₂, 180° C. and ambient pressure at a Gaseous Space Hourly Velocity (GSHV) of 1000/hr for 15 hours. After reduction, a 25 wt. % sorbitol feed consisting of a molar ratio of Sorbitol/NaOH of 10:1 was pumped through the reactor under 120 bar and 210° C. under a Liquid Space Hourly Velocity (LSHV)=2/hr. The test was run for 350 hours under these conditions. An average of 71% sorbitol conversion was achieved. Selectivity for three major products, ethylene glycol, propylene glycol, and glycerin, were 13 molar %, 27.8 molar %, and 37.8 molar %, respectively.

It is to be understood that the embodiments and claims are not limited in application to the details of construction and arrangement of the components set forth in the description. Rather, the description provides examples of the embodiments envisioned, but the claims are not limited to any particular embodiment or a preferred embodiment disclosed and/or identified in the specification. The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other compositions, structures, methods, and systems. In addition, it is to be understood that the phraseology and terminology employed herein are for the purpose of description and should not be regarded as limiting the claims.

1. A hydrothermally-stable, extruded catalyst or catalyst support comprising a zirconium compound and a polyacid/promoter material, wherein the zirconium compound and polyacid/promoter material are combined to form a zirconyl-promoter precursor having a molar ratio between 2:1 and 20:1; the polyacid/promoter material is selected from the group consisting of a polyacid, a polyacid comprising the oxide or acid form of chromium, molybdenum, or tungsten, and combinations thereof; and the zirconyl-promoter precursor is extruded in an absence of any binder, extrusion aid or stabilizing agent.

2. A hydrothermally-stable, extruded catalyst or catalyst support consisting essentially of a zirconium compound and a polyacid/promoter material, wherein the zirconium compound and polyacid/promoter material are combined to form a zirconyl-promoter precursor having a molar ratio between 4:1 and 16:1; the polyacid/promoter material comprises the oxide or acid form of chromium; and the zirconyl-promoter precursor is extruded in an absence of any binder, extrusion aid or stabilizing agent.

3. The catalyst or catalyst support of claim 1 wherein the molar ratio of the zirconium compound to polyacid/promoter material is about 8:1.

4. The catalyst or catalyst support of claim 1 wherein the zirconium compound is selected from the group consisting of zirconium halides, zirconyl halides, zirconium nitrates, zirconyl nitrates, zirconyl organic acids, and combinations thereof.

5. The catalyst or catalyst support of claim 1 wherein the polyacid/promoter material is selected from the group consisting of CrO₃, Cr₂O₃, and combinations thereof.

6. The catalyst or catalyst support of claim 1 wherein the extruded catalyst or catalyst support has a crystalline structure comprising 50 wt % to 100 wt % tetragonal phase of zirconium oxide.

7. The catalyst or catalyst support of claim 1 wherein the extruded catalyst or catalyst support has a crystalline structure comprising more than 85 wt % tetragonal phase of zirconium oxide.

8. The catalyst or catalyst support of claim 1 having a crush strength in a range between 67 N/cm and 178 N/cm.

9. The catalyst or catalyst support of claim 1 further comprising one or more catalytically active metals and optionally one or more promoters.

10. The catalyst or catalyst support of claim 1 having a surface area in a range between 20 m²/g and 150 m²/g.

11. A method of preparing a catalyst or catalyst support consisting essentially of zirconium oxide and a polyacid/promoter material, the method comprising:
a) providing a polyacid/promoter material selected from the group consisting of a polyacid, a polyacid comprising the oxide or acid form of chromium, molybdenum, or tungsten, phosphoric acid, sulfuric acid, acetic acid, citric acid, and combinations thereof;
b) providing a zirconium compound;
c) mixing the polyacid/promoter material with the zirconium compound in an amount that yields a solution having an molar ratio of zirconium to polyacid/promoter material between 2:1 and 20:1;
d) precipitating a zirconium-promoter precursor by mixing an aqueous basic solution with the zirconium-promoter solution;
e) filtering and drying the zirconium-promoter precursor;
f) forming the zirconium-promoter precursor into a shape suitable as a catalyst or catalyst support; and
g) calcining the formed zirconium-promoter precursor to form the finished catalyst or catalyst support.

12. A method of preparing a catalyst or catalyst support consisting essentially of zirconium oxide and a polyacid/promoter material, the method comprising:
a) providing a polyacid/promoter material selected from the group consisting of a polyacid, a polyacid comprising the oxide or acid form of chromium, molybdenum, or tungsten, phosphoric acid, sulfuric acid, acetic acid, citric acid, and combinations thereof;
b) providing a zirconium compound;
c) precipitating the zirconium compound using an aqueous basic solution and washing the zirconium precipitate;
d) mixing the zirconium precipitate with the polyacid/promoter material in an amount that yields a zirconium-promoter precursor having an molar ratio of zirconium to polyacid/promoter material between 2:1 and 20:1;
e) filtering and drying the zirconium-promoter precursor;
f) forming the zirconium-promoter precursor into a shape suitable as a catalyst or catalyst support; and
g) calcining the formed zirconium-promoter precursor to form the finished catalyst or catalyst support.

13. The method of claim 11 wherein the molar ratio of the zirconium to polyacid/promoter material is about 8:1.

14. The method of claim 11 wherein the molar ratio of zirconium to polyacid/promoter material is about 13:1.

15. The method of claim 11 wherein the zirconium compound is selected from the group consisting of zirconium halides, zirconyl halides, zirconium nitrates, zirconyl nitrates, zirconyl organic acids, and combinations thereof and the polyacid/promoter material is selected from the group consisting of CrO₃, Cr₂O₃, and combinations thereof.

16. The method of claim 11 wherein the zirconium compound is ZrO(NO₃)₂ and the polyacid/promoter material is CrO₃.

17. The method of claim 11 wherein the forming step f) comprises extruding the zirconyl-promoter precursor.

18. The method of claim 11 wherein the forming step f) comprises extruding the zirconyl-promoter precursor in an absence of any binder, extrusion aid or stabilizing agent.

19. The method of claim 11 wherein the drying step e) comprises drying the precursor to achieve a loss of ignition of the precursor between 60 wt. % and 70 wt. %.

20. The method of claim 11 wherein the drying step e) comprises drying the precursor to achieve a loss of ignition of the precursor between 65 wt. % and 67 wt. %.
